(19) United States
(12) Patent Application Publication
(10) Pub. No.: US 2021/0058652 A1
(43) Pub. Date: Feb. 25, 2021

(54) SYSTEM AND METHOD OF BUILDING A DISTRIBUTED NETWORK FOR ESSENCE MANAGEMENT AND ACCESS

(71) Applicant: GRASS VALLEY LIMITED, Newbury (GB)

(72) Inventors: James Westland CAIN, Newbury (GB); Ben RUSSELL, Reading (GB)

(21) Appl. No.: 16/998,226

(22) Filed: Aug. 20, 2020

Related U.S. Application Data
(60) Provisional application No. 62/890,358, filed on Aug. 22, 2019.

(51) Int. Cl. H04N 21/231; H04N 21/2343; H04N 21/239; H04N 21/472; H04N 21/475

(52) U.S. Cl. CPC H04N 21/23106; H04N 21/234363; H04N 21/4755; H04N 21/47202; H04N 21/2393

(57) ABSTRACT

A system is provided for building a distributed network for essence management and access. The system includes a media asset recording system that generates high quality copies and proxy copies of a media asset and an essence database that stores these copies. Moreover, a first source index stores asset entries that correspond to each of the copies of the media asset, respectively, with the media asset entries including metadata for a resolution, a video codec and an audio codec information relating to each respective copy. Moreover, a media asset monitor dynamically updates the respective media asset entries upon the media asset recording system generating each copy of the media asset. The system also includes a media essence provider that accesses a copy of the media asset based on a media access request from a media request application on a client device that specifies required parameters for the media asset.

### CROSS REFERENCE TO RELATED APPLICATIONS

The present application claims priority to U.S. Provisional Application No. 62/890,358, filed Aug. 22, 2019, the entire contents of which are hereby incorporated by reference.

### TECHNICAL FIELD

The present disclosure generally relates to a system and method management and distribution of media content, and, more particularly, to a system and method of dynamically building a potentially distributed network for essence management and access.

### BACKGROUND

With the ever increasing amount of media content that is being generated and stored for later recall, entities and individuals are constantly searching for techniques to minimize resource consumption and reduce costs for such media storage. Currently, content consumers typically archive one or multiple versions of media essence in a specific location and for recall at a subsequent point in time. By doing so, the amount of media essence stored at a given location can quickly become very costly and in some instances unmanageable.

### SUMMARY

Accordingly, to effectively handle the creation and management of media content, a system and method is provided that enables globally distributed editing functions where a particular application can select and access the “best” form and location of one or more different copies the media essence for each particular use case.

Thus, in an exemplary embodiment, a system is provided for building a distributed network for essence management and access. In this aspect, the system includes a media asset recording system configured to generate a plurality of copies of a media asset including a high quality copy and at least one proxy copy of the media asset, with the high quality copy having a higher resolution than the at least one proxy copy; a premises source index configured to store a plurality of media asset entries corresponding to each of the plurality of copies of the media asset, respectively; a media asset monitor configured to dynamically update the respective media asset entries in the premises source index upon the media asset recording system generating the high quality copy and the at least one proxy copy of the media asset; a worker configured to generate a copy of the at least one proxy copy of the media asset and write the generated copy of the at least one proxy copy to an essence cache of a cloud computing resource; a cloud source index configured to generate at least one media asset entry corresponding to the generated copy of the at least one proxy copy in the essence cache of the cloud computing resource; wherein the cloud source index is configured to generate a media access reference that dynamically links the at least one media asset entry to the plurality of media asset entries stored in the premises source index; and wherein the cloud computing resource is configured to access the high quality copy of the media asset from the premises source index using the media access reference dynamically linking the respective copies of the media asset and in response to a media access request from a media request application on a client device, with the media access request including media asset parameters requiring the high quality copy of the media asset.

In another exemplary aspect, the media request application comprises at least one of a web browser, an editing software, and a render engine.

In another exemplary aspect, the media request application comprises a web browser that includes a plurality of user-defined fields that are configured to receive user inputs that enable a user to specify the media asset parameters that include a time needed for the high quality copy of the media asset and a resolution required for the high quality copy of the media asset.

In another exemplary aspect, the system includes an essence database communicatively coupled to the media asset recording system and configured to store the plurality of copies of the media asset including the high quality copy and the at least one proxy copy of the media asset. Moreover, the premises source index can be configured to store media asset metadata corresponding to the plurality of media asset entries, with the media asset metadata including a content type, a resolution format, a time length, and an ownership information of each corresponding media asset stored in the essence database.

In another exemplary aspect, the cloud computing resource is configured to redirect the media access request to the premises source index to access the high quality copy of the media asset from the essence database when the media access request includes the media asset parameters that correspond to the media asset metadata identifying the respective media asset in the essence database.

In an additional embodiment, a system is provided for building a distributed network for essence management and access. This aspect, the system includes a media asset recording system configured to generate a plurality of copies of a media asset including a first copy and at least one second copy of the media asset that is a proxy of the first copy with a different quality than the first copy; a first source index configured to store a plurality of media asset entries corresponding to each of the plurality of copies of the media asset, respectively; a media asset monitor configured to dynamically update the respective media asset entries in the first index upon the media asset recording system generating at least one of the first and second copies of the media asset; a worker configured to write the second copy of the media asset to an essence cache located remotely from the first source index; a second source index coupled to the essence cache and located remotely from the first source index, with the second source index being configured to store at least one media asset entry corresponding to the second copy of the media asset that is in the essence cache; wherein at least one of the first and second source indices is configured to generate a media access reference that dynamically links the at least one media asset entry therein to a corresponding media asset entry in the other of the first and second source indices; and wherein at least one of the first and second source indices is configured to access one of the first and second copies of the media asset from other of the first and second source indices using the media access reference dynamically linking the respective copy of the media asset and in response to a media access request from a media request application on a client device, with the media access request including media asset parameters for requesting the one of the first and second copies of the media asset.

In another exemplary embodiment, a system is provided for building a distributed network for essence management and access. In this aspect, the system includes a media asset recording system configured to generate a plurality of copies of a media asset including a high quality copy and a proxy copy of the media asset that has a lower resolution than the high quality copy; an essence database configured to store each of the plurality of copies of the media asset; a first source index configured to store a plurality of media asset entries corresponding to each of the plurality of copies of the media asset, respectively, wherein each of the plurality of media asset entries including metadata for each respective copy, with the metadata including at least a resolution, a video codec and an audio codec information relating to the respective copy; a media asset monitor configured to dynamically update the respective media asset entries in the first source index upon the media asset recording system generating at least one of the high quality copy and the proxy copy of the media asset; and a media essence provider configured to access a copy of the media asset having a highest available resolution in response to a media access request from a media request application on a client device that specifies required parameters for the media asset, such that the media essence provider references the first source index to identify the copy of the media asset having the highest available resolution based on the specified and required parameters for the media asset.

Moreover, the system can further include a worker configured to write the proxy copy of the media asset to an essence cache located remotely from the first source index; and a second source index coupled to the essence cache and located remotely from the first source index, with the second source index being configured to store at least one media asset entry corresponding to the second copy of the media asset that is in the essence cache. In this aspect, at least one of the first and second source indices is configured to generate a media access reference that dynamically links the at least one media asset entry therein to a corresponding media asset entry in the other of the first and second source indices.

In another exemplary aspect, at least one of the first and second source indices is configured to access one of the high quality and proxy copies of the media asset from other of the first and second source indices using the media access reference dynamically linking the respective copy of the media asset and in response to the media access request from a media request application on a client device, with the media access request including media asset parameters for requesting the respective copy of the media asset.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

FIG. 1A is a block diagram of a system for building a distributed network for essence management and access according to an example embodiment.

FIG. 1B is a block diagram of a system for building a distributed network for essence management and access according to another example embodiment.

FIG. 2 illustrates a block diagram of an exemplary implementation of a system for accessing media assets using the distributed system shown in FIGS. 1A and 1B.

FIG. 3 is a flowchart of a method for building a distributed network for essence management and access according to an example embodiment.

FIG. 4 illustrates a flowchart for a method for accessing media assets using the distributed system shown in FIG. 1A.

FIG. 5 is a block diagram of a system for building a distributed network for essence management and access according to another example embodiment.

FIG. 6 is a block diagram of a system for building a distributed network for essence management and access according to another example embodiment.

FIG. 7 is a block diagram illustrating a computer system on which aspects of the present systems and methods may be implemented in accordance with an exemplary aspect.

### DETAILED DESCRIPTION

Various aspects of the disclosure are now described with reference to the drawings, wherein like reference numerals are used to refer to like elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below. In other instances, well-known structures and devices are shown in block diagram form in order to facilitate description of one or more aspects. The following presents a simplified summary of one or more aspects of the disclosure in order to provide a basic understanding thereof.

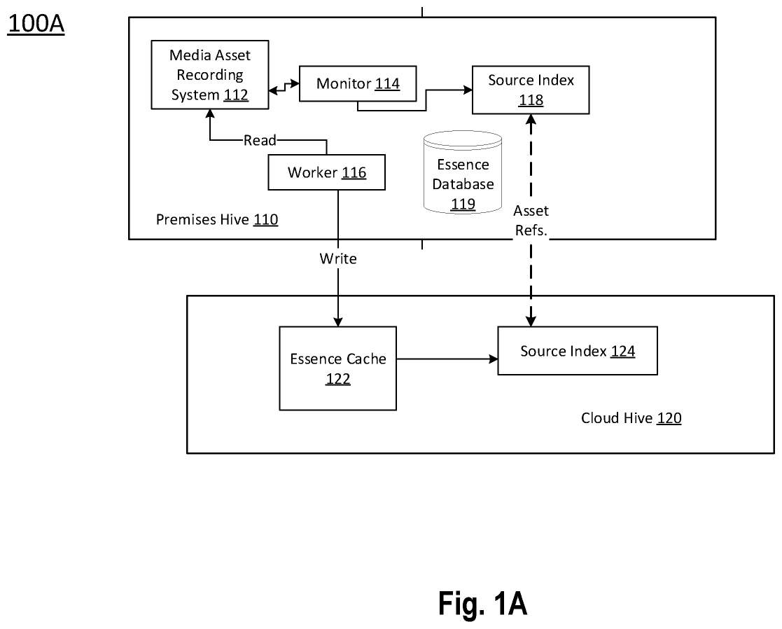

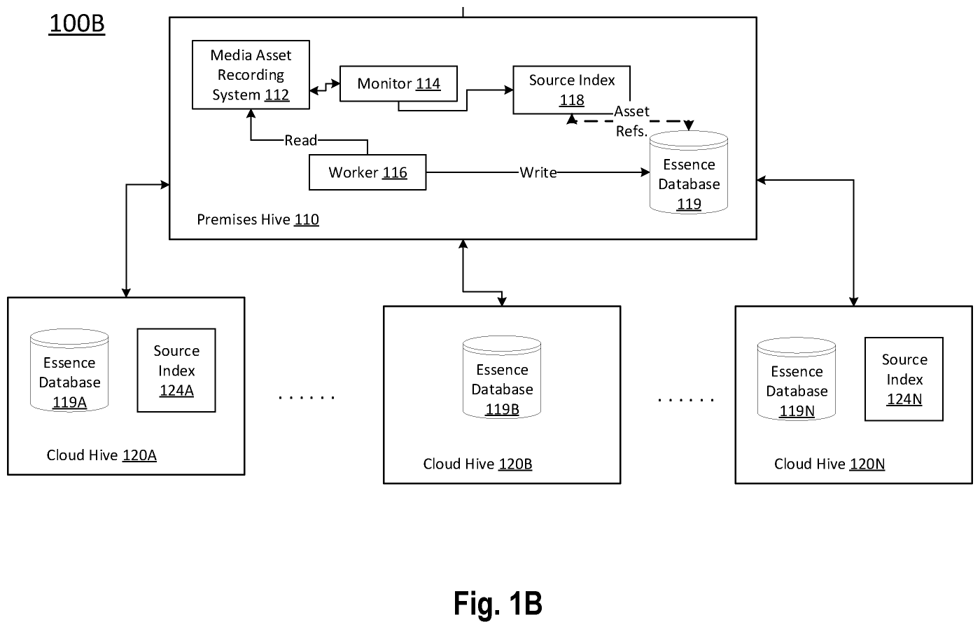

FIG. 1A is a block diagram of a system for building a distributed network for essence management and access according to an example embodiment. For purposes of this disclosure, essence can include any type of digital media data, such as audio, video, captions, associated temporal data, and the like. Moreover, essence can take on many different forms and qualities and stored in many different locations. According to the exemplary aspect, a system 100A is provided to build a distributed graph/database of locations that store different forms of media essence that are configured to be subsequently accessed for a given application and in response to a media access request. Effectively, the system enables globally distributed editing functions that enable a particular application to select and access the best form and location of one or more different copies the media essence for each particular use case, and also, possibly combining renditions depending upon such use case.

As shown in FIG. 1A, the system 100A generally can include a premises hive 110 and a cloud hive 120. Each hive can be provided as a system, network or architecture of components, for example, will be described in detail below. Moreover, it should be appreciated that the premises hive 110 can be located at an entity's physical location(s) while the cloud hive 120 can generally be provided as an online/remote file storage service or cloud computing and processing service. Examples of such services include Amazon® Web Services (“AWS”), Microsoft® Azure (“Azure”) and Google Cloud Platform® (“GCP”) computer services. Moreover, it is contemplated that the distributed network can be comprised of a plurality of premises hives 110 and one or more cloud hives 120 to provide a distributed network of media essence across a broad geographic area (e.g., spanning across multiple continents, for example).

As shown in the exemplary embodiment, the premises hive 110 can include a media asset recording system 112, which can be any type of device for recording and/or obtaining media essence. For example, in one aspect, the media asset recording system 112 can be a third-party system (e.g., a video camera at a live event) configured to capture live media content on a real-time basis. In another exemplary aspect, the media asset recording system 112 can be a video server configured to receive such media assets from a camera or other device configured to capture and/or provide media essence as would be appreciated to one skilled in the art. In either exemplary aspect, the media asset recording system 112 is configured to generate both a quality copy and a proxy copy of the obtained and/or recorded media asset. Moreover, the proxy copy(ies) can be in a different formatted version of the media asset than the quality copy, such as a low(er) resolution version of the captured media content than the quality copy. Moreover, it should be appreciated that while the media asset recording system 112 is shown to be located in the premises hive 110, the media asset recording system 112 can be located remotely to the other components of premises hive 110, such as, for example, if the media asset recording system 112 is a live production camera located at a live event venue.

As further shown, the media asset recording system 112 is communicatively coupled to a monitor 114 that is configured to obtain/receive a notification of when new media asset has been generated or received. In one aspect, the monitor 114 can continuously or periodically poll the media asset recording system 112 to determine if any new media assets have been recorded/obtained. In another exemplary aspect, the media asset recording system 112 is configured to push the notification of a new media asset to the monitor 114. In either case, for example, the media asset recording system 112 can maintain an event log of the status change (e.g., creation, modification, deletion) of each media asset that can be read out by the monitor 114.

Upon receiving the notification of any state change of the media asset, the monitor 114 is further configured to generate a new index or entry (or modify an existing entry) in the local source index 118 coupled thereto and located in the premises hive 110 for the quality copy (e.g., high resolution copy) of the new media asset. Likewise, the monitor 114 is further configured to generate a new index or entry (or modify an existing entry) in the local source index 118 for the one or more proxy copies (e.g., lower resolution copies) of the new media asset.

In one aspect, the media asset recording system 112 stores both the quality and proxy copies of the media asset when, for example, the media asset recording system 112 is a video server. In another exemplary aspect, the premises hive 110 can include an essence database 119 (e.g., a media asset or video server) that is communicatively coupled to the media asset recording system 112 and is further configured to store the quality and proxy copies of the media asset. In either case, the source index 118 can be configured to store entries for each such entry that includes metadata (e.g., content, resolution format, time length, copyright and ownership information, etc.) associated with each copy of the media asset and, most importantly, the address location of the media asset in the media asset recording system 112 and/or essence database 119, for example.

As further shown, the premises hive 110 includes a worker 116 that is configured as an interface between the premises hive 110 and cloud hive 120. More particularly, in one aspect, the worker 116 can be configured as a proxy copy transmitter than can be invoked by the monitor 114 to copy the proxy copy of the media asset to the cloud essence store. For example, upon invocation by monitor 114, the worker 116 is configured to read the proxy copy from the media asset recording system 112 (or essence database 119) and copy the proxy copy of the media asset to the cloud essence cache 122.

In addition, upon receiving the proxy copy, the essence cache 122 is configured add a new entry in the cloud source index 124. Similar to premises source index 118, the cloud source index 124 can be configured to store entries for each such entry that includes metadata (e.g., content, resolution format, time length, copyright and ownership information, etc.) associated with each proxy copy of the media asset stored in the cloud essence cache 122, including the address location of the media asset in the cloud essence cache 122.

Moreover, the monitor 114 is configured to add a media access reference, such as a URI or URL, to the source index 124 that links the entry of the proxy copy of the media asset stored in the essence cache 122 to the entries in the premises source index 118 that are associated with the different copies (e.g., quality and proxy) copies of the media asset that are stored locally at the premise, for example, by the media asset recording system 112 and/or essence database 119. As will become readily apparent from the examples described below, if the source index 124 receives a media access request for a quality copy of the media asset, the media access reference indexed therein can be referenced to identify the location and related metadata of the quality copy of the asset to ensure this version of the media asset satisfies the formatting (e.g., resolution) requirements in the media access request.

It should be appreciated that while the foregoing description of system 100A in FIG. 1A provides a fairly simplistic example by way of a single media asset with only a few copies (e.g., a quality and proxy copy) of the asset, the distributed system with many premises storing hundreds, thousands, or even more media assets can facilitate a quick and dynamic access of each media asset with a format that is suitable to a given media access request by providing a plurality of media access references in each of the source indices at each location that effectively enable globally distributed editing functions of the most appropriate form and location of one or more different copies the media essence. That is, the distributed network of media essence assets and corresponding source indices effectively creates a domain name system (DNS) that associates various information of each of copy of each media essence with the participating entities (e.g., premises hive 110 and cloud hive(s) 120) in the distributed network.

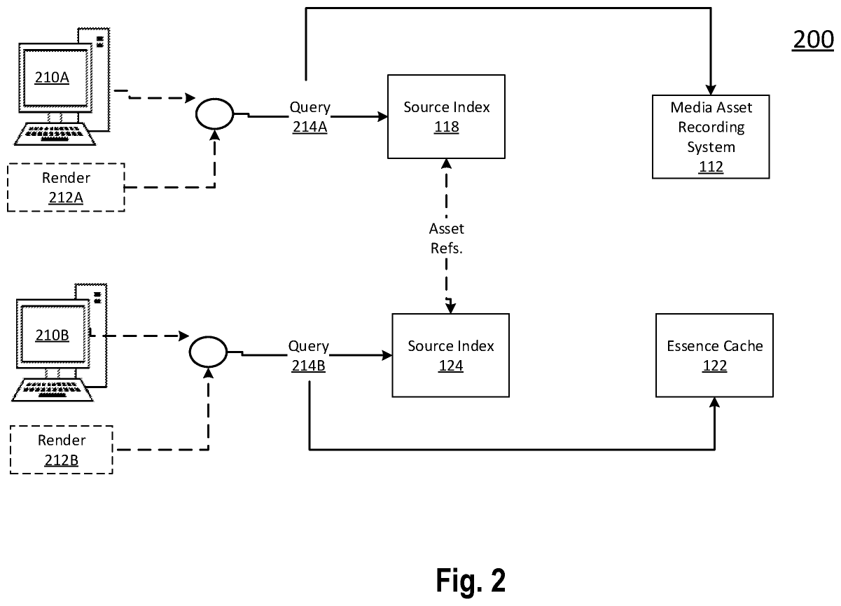

FIG. 2 illustrates a block diagram of an exemplary implementation of a system for accessing media assets using the distributed system shown in FIG. 1A. As shown, the system 200 includes a plurality of users (e.g., client devices 210A and 210B) that are configured to generate media asset requests according to an exemplary embodiment. For example, the client devices 210A and 210B can be any type of client computing device, such as a personal computer, web server, smartphone, or the like, that includes a web browser with a video player/editor configured to generate media access request for a give media asset.

Moreover, the media access requests can be configured to specify required parameters for such assets. For example, the web browser may include a plurality of user defined fields (e.g., drop down selections) that enable a user to specify required parameters for the media asset, including time needed, resolution/quality, video codecs, audio codecs, bitrate, audio channels (e.g., mono, stereo, etc.) and so forth. With these defined parameters, the user generated request for a specific media asset is transmitted to and interpreted by the respective source asset.

In a first example, a user of client device 210A generates a web browser to access a first asset and may, for example, specify a required time when the asset is needed. The browser in turn is configured to generate a query 214A (e.g., a media access request) to the premises source index 118 to dynamically determine the best essence copy to access. For example, if the user needs a media copy quickly and high resolution (e.g., 4K resolution) is not critical, the source index 118 can be configured to access the proxy copy of the media asset stored in media asset recording system 112, for example. In another example, if the request is generated by a mobile device or web browser, there may be limited support for video/audio codecs and the request will specify the type of codecs supported by the requesting device or application.

In general, it is noted that a web browser is described in the exemplary aspect as generating the query to access media assets, the requesting application can be any type of client user interface or other render engine that is configured to access such media essence. For example, in another exemplary aspect, the requesting application can be an editing software. In this case, the editing software may require a frame-accurate copy of the media whereas a simple player application will not need such a frame-accurate copy. Other examples of limiting parameters can include the type of network (e.g., Wi-Fi vs. 4G network instead of a wired connection) that may also dictate what is considered the best essence copy to access and provide to the requesting device and/or software application. As such, the limiting parameters will be specific to the requesting application as would be appreciated to one skilled in the art.

In any event, according to the exemplary aspect, the source index 118 can be configured to locate and access the proxy copy that is the best essence copy to use by referencing the user specified parameters in the media access request (e.g., time needed and desired format) with the metadata stored in and associated with the entry in premises source index 118 (e.g., media asset size and actual format). For example, if the user needs the media asset in one hour and high quality (e.g., 4K resolution) is not critical, the system can be configured to determine that the proxy copy is the best essence copy to provide as it is the only essence copy that can be made available to the user in the desired time given the available bandwidth between the media asset recording system 112 and the web browser 210A.

Moreover, in a variation of this aspect, the system can also be configured to determine that the proxy copy stored in the essence cache 122 of the cloud hive 120 can be provided more quickly to the web browser 210A than the same proxy copy stored by media asset recording system 112. In this aspect, using the media access references stored in each of source index 118 and source index 124 the confirm the multiple locations of the same proxy copy of the media asset, the source index 118 can direct the user defined media access request to access the proxy copy directly from essence cache 122.

In another exemplary aspect, a render machine 212A that may wish to generate a final version of the media asset for media production can generate request (also shown as query 214A), but in this instanced a high quality resolution is needed, but time is not critical, with such parameters also defined in the media asset request sent to the source index 118. In this instance, the source index 118 as the premises hive 110 can be configured to locate the high quality version of the asset stored in the media asset recording system 112. The query 214A can in turn be redirected to the media asset recording system 112, such that the render machine 212A can directly obtain a copy of the high quality media asset therefrom. It is also noted that in the high quality version of the asset can be considered a first copy and the proxy copy can be considered a second copy that, in one aspect, has a lower resolution than the first copy of the media asset.

In yet other exemplary aspect a query 214B can be directed to the cloud hive source index 124. For example, a remote user of web browser 210B can generate a media asset request for proxy copy stored in essence cache 122. In this example, the source index 124 redirects the query 214B directly to the essence cache 122 to enable the browser 210B to directly access the proxy copy of the media asset therefore. In contrast, if the render machine 212B generates the query 214B to source index 124, but requires a high quality copy of the media asset, the source index 124 is configured to access the relevant media access reference to redirect the query 214B to the source index 118. In turn, the source index 118 contains an entry therein that identifies the location of the high quality copy of the media asset in the media asset recording system 112. As a result, the render machine 212B is configured using the distributed graph of quality and proxy copies of the media asset to obtain the “best” essence copy directly from the media asset recording system 112.

According the exemplary system 100A and 200 is configured to build a distributed graph/database of locations that store different forms of media essence that are configured to be subsequently accessed for a given application and in response to a media access request. As a result, the exemplary system 100A and 200 provides for globally distributed editing functions that enable a particular application to select and access the best form and location of one or more different copies the media essence for each particular use case, and also, possibly combining renditions depending upon such use case.

FIG. 1B is a block diagram of a system 100B for building a distributed network for essence management and access according to another example embodiment. In general, the components of system 100B shown in FIG. 1B generally correspond to those described above with respect to FIG. 1A of which the details and configurations of such components will not be repeated herein. However, in this refinement of the exemplary aspect, a single source index 118 is provided at the premises hive 110 that is contains media access information to one or more sites/nodes (e.g., premises hive 110 itself). Optionally, one or more additional remote nodes can be dynamically added at a later point in time optionally and dynamically for the distributed network of media essence.

More particularly, the premises hive 110 includes monitor 114 which can be configured to detect a new media essence generated and/or obtained by media asset recording system 112 (as described above) or even a media asset located remotely from premises hive 110. As further described above, the monitor 114 is configured to prompt worker 116 to dynamically read the media essence from media asset recording system 112 and generate one or more proxy copies of the media essence to be stored in essence database 119. It should be appreciated that essence database 119 can be located on site at premises hive 110 and/or remotely at another node, for example.

In addition, according to the exemplary embodiment shown in FIG. 1B, the distributed system 100B is configured to dynamically add remote nodes (e.g., cloud hives 120A, 120B to 120N) at optional points in time to massively grow the distributed network. For example, in one exemplary aspect, premises hive 110 can receive a request to dynamically add one or more of cloud hives 120A, 120B to 120N, which each may have its own database of media essence. This request may be generated by a system administrator, for example. Upon receiving the request, premises hive 110 can be configured to query the node to be added to determine the media essence located at each node (to be added to the network). For example, there may be offline media content located at the remote node being added to the distributed network. Upon receiving the identification of media essence, which includes metadata of the media essence identifying the various copy parameters (e.g., resolution quality), as discussed above, the premises hive 110 is configured to update its source index 118 to store entries for each copy of each media essence located at each node, which can include metadata (e.g., content, resolution format, time length, copyright and ownership information, etc.) associated with each copy of the media asset stored therein (e.g., in essence databases 119A, 119B and/or 119N).

In a refinement of this exemplary aspect of the embodiment shown in FIG. 1B, a separate source index can be generated and stored at one or more of the remote nodes (e.g., cloud hives 120A to 120N). For example, premises hive 110 can generate each source index 124A and 124N that includes indices for each copy of each media essence (including the parameter metadata) as described, and then transmit such sources indices to the respective remote node (i.e., cloud hive 120A and 120N, respectively) to be stored thereon. As should be appreciated, the system 100B can be dynamically (and optionally) grown to include a plurality of nodes with one or more of the nodes having source indexes for accessing the best essence copy of the media asset as described herein.

As a result, the exemplary system 100B is configured to dynamically index asset locations for essence that pre-exists at customer sites. For example, cloud hive 120B with essence database 119B can be configured essentially as a media essence archive that can be added to the network upon system administrator request, fore example. When the cloud hive 120B is added to the distributed media essence database, the premises hive 110 can be configured to dynamically index all media essence stored in the essence database 110B, for example, by generating a media essence audit request to cloud hive 120B that request a listing of all media essence and respective media essence parameters for each such media essence. In turn, this information can be generated/accessed by cloud hive 120B and passed by to premises hive 110, which in turn is configured to generate media essence entries for the media essence (and metadata parameters thereof) that are dynamically added in source index 118, such that premises hive 110 is effectively configured as a media essence access manager. Thus, in one aspect, to the extent a particular cloud hive (e.g., cloud hive 120B) receives a media access request from an end user (e.g., a web browser), and does not include a source index to identify the “best” copy of the media essence, the specific cloud hive 120B can be configured to relay or transfer the request to premises hive 110 for processing thereof using the techniques described herein. Accordingly, from the end users perspective, system 100B appears as a single unified system of media assets even as it can be constantly and dynamically grown as described herein.

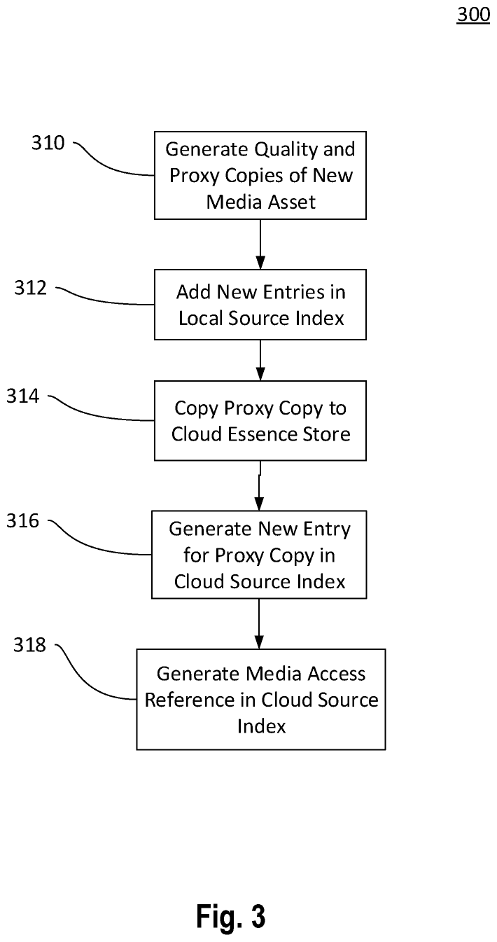

FIG. 3 is a flowchart of a method for building a distributed network for essence management and access according to an example embodiment. In general, it should be appreciated that the exemplary method as shown can be implemented using the components of systems 100A and 100B as described above.

As shown in FIG. 3, the method 300 begins at step 310 a media asset recording system 112 captures or otherwise obtains a media asset and generates both a quality copy and one or more proxy copies of the obtained and/or recorded media asset. As described above, the proxy copy(ies) can be in a different formatted version of the media asset than the quality copy, such as a low(er) resolution version of the captured media content than the quality copy.

Next, at step 312 upon receiving as notification of a new media asset, a monitor 114 is further configured to generate a new index or entry (or modify an existing entry) in a local source index 118 for both the quality copy (e.g., high resolution copy) of the new media asset and the one or more proxy copies (e.g., lower resolution copies) of the new media asset.

As described above, the premises hive 110 includes a worker 116 that is configured as an interface between the premises hive 110 and cloud hive 120. At step 314, the worker 116 is configured as a proxy copy transmitter and, when invoked by the monitor 114,k copies a proxy copy of the media asset to the cloud essence store. In addition, upon receiving the proxy copy, the essence cache 122 adds a new entry in the cloud source index 124 at step 316. Similar to premises source index 118, the cloud source index 124 can be configured to store entries for each such entry that includes metadata (e.g., content, resolution format, time length, copyright and ownership information, etc.) associated with each proxy copy of the media asset stored in the cloud essence cache 122, including the address location of the media asset in the cloud essence cache 122.

Finally, at step 318, a media access reference is added to the source index 124 that links the entry of the proxy copy of the media asset stored in the essence cache 122 to the entries in the premises source index 118 that are associated with the different copies (e.g., quality and proxy) copies of the media asset that are stored locally at the premise. As a result of the exemplary method of FIG. 3, a distributed system can be generated with many premises storing hundreds, thousands, or even more media assets to facilitate a quick and dynamic access of each media asset with a format that is suitable to a given media access request by providing a plurality of media access references in each of the source indices at each location that effectively enable globally distributed editing functions of the most appropriate form and location of one or more different copies the media essence.

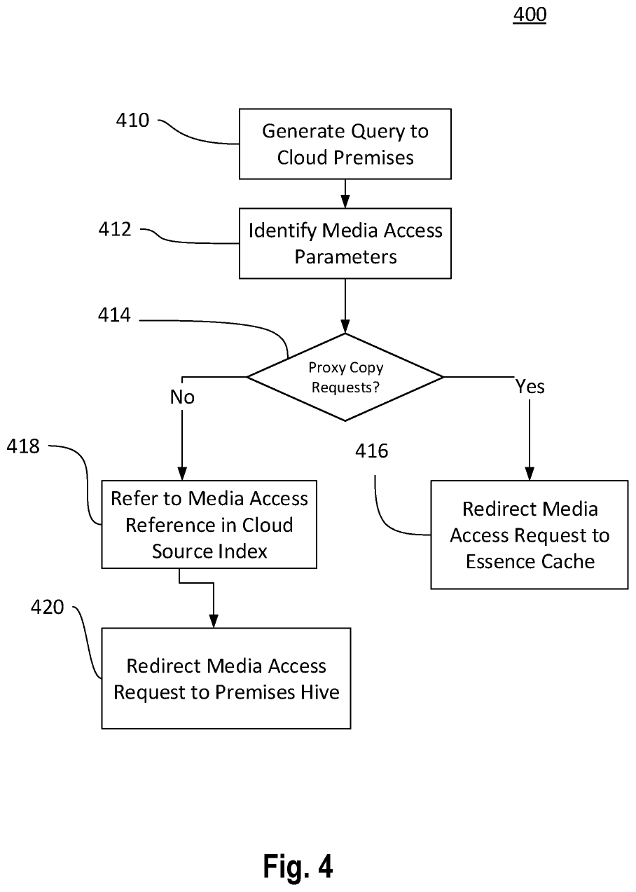

FIG. 4 illustrates a flowchart for a method for accessing media assets using the distributed system shown in FIG. 1A. It should be appreciated that the exemplary method shown in FIG. 4 illustrates an example of a media asset request as shown in FIG. 2 and described above, for example.

As shown, initially at step 410 a user (e.g., a web browser) or a render machine can generate a media access request that is transmitted to a source index. For example, in the example shown, the media access request is transmitted to a source index 124 on cloud hive 120, but such request can also be transmitted to source index 118 in the premises hive 110.

Next, at step 412, the source index 124 can be configured to parse the media access request to identify specified parameters of the media asset request. For example, as described above, the web browser can include a plurality of user defined fields (e.g., drop down selections) that enable a user to specify required parameters for the media asset, including time needed, resolution/quality, and so forth. The requesting device or application (e.g., the web browser) can also be configured to automatically determine network settings. For example, the web browser can be configured to automatically determine the quality/bandwidth of the user's Internet and network connections, and also dynamically determine any changes in these settings. In this case as an example, if the user's phone switches from using a 4G mobile data to their home Wi-Fi, the web browser can dynamically update its media access request for a higher bandwidth stream without user intervention.

Upon parsing the specified parameters, the source index at step 414 can determine the “best” essence copy for the media asset. For example, if only a proxy copy is needed and that proxy copy is stored in the essence cache in the cloud hive associated with the received source index, the media access request can be redirected to the essence cache at step 416 to access the proxy copy.

Otherwise, if the source index 124 determines at step 414 that a high quality version of the media asset is needed, the source index 124 is configured to access the media access reference at step 418 to identify the location of the high quality asset. Yet further, the user can also specify a required time (e.g., within one hour) to receive a copy of the media access. In this case, the source index 124 can be configured to determine the “best” copy of the media asset (e.g., highest resolution) that is located within an acceptable distance of the requesting user, for example, by determining file size and available bandwidth to ensure the file can be transmitted within the specified and required time. The system can then select and transmit this file accordingly.

In either case, once the “best” copy of the media asset is determined and located, the media access request at step 420 is redirected to the appropriate premises hive 110 (based on the media access reference) to obtain the high quality copy of the media asset required for the rendering, for example. Accordingly, using the foregoing described method, it should be readily apparent that a distributed graph is built based on multiple source indices that reference each various copy of the media access to enable a request (generated by a web browser, rendering machine, or the like) to access the best essence copy of the media asset.

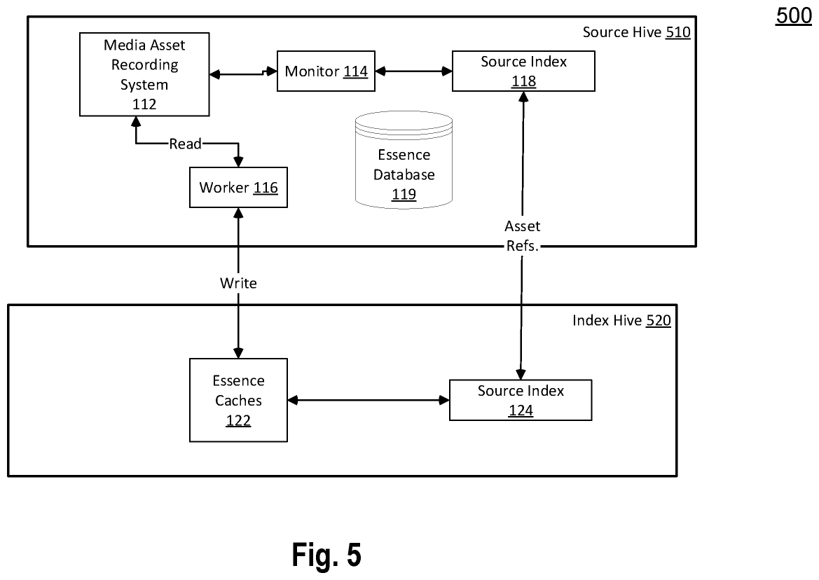

FIG. 5 is a block diagram of a system for building a distributed network for essence management and access according to another example embodiment. In general, FIG. 5 illustrates a system 500 with the same components as shown in system 100A of FIG. 1 and shown above. That is, system 500 generally provides a system for building a distributed network for essence management and access according to an example embodiment. However, system 100A includes a premises hive 110 and a cloud hive 120.

However, in an alternative embodiment as shown in FIG. 5, each hive can be more generally provided in a physical location, or cloud platform, or any combination of the two. As shown, system 500 includes source hive 510 (e.g., a first hive) and index hive 520 (e.g., a second hive). In general, it is noted that each of the first and second hives (and all the components/modules therein) are located remotely from each other, such as being distributed across a network. Again, it is also noted that each hive can be provided as a system, network, software platform or architecture of components, for example, but otherwise, the components of source hive 510 and index hive 520 can correspond to the components of premises hive 110 and cloud hive 120, respectively, as discussed above.

Thus it should be appreciated that the source hive 510, can be implemented in a cloud platform or network, for example, where content can be generated and indexed according the exemplary techniques described above. Similarly index hive 520 can include essence cache 122 that stores a proxy copy of the media content, such that the index hive 520 can quickly provide the proxy copy to a web browser or other type of render engine using source index 124 as also described above. The details of the media essence access will not be repeated herein, but it should be appreciated that system 500 generally provides additional flexibility of the implementation of the techniques described herein by enabling the system to place each hive (e.g., source hive 510 and index hive 520) in either a physical location (e.g., a physical premises) or in a cloud based infrastructure/network.

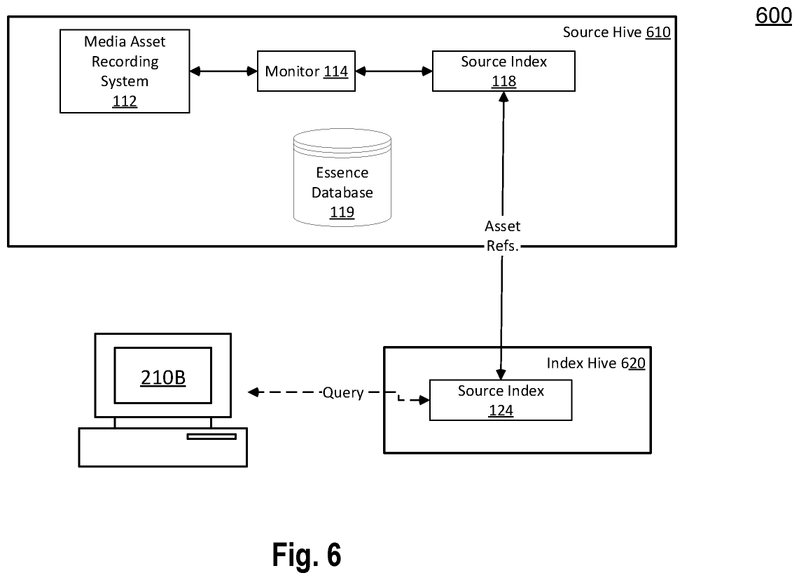

FIG. 6 is a block diagram of a system 600 for building a distributed network for essence management and access according to another example embodiment. As shown, FIG. 6 is a variation of FIG. 5 and includes the same components as described. However, in this embodiment, the source hive 610 does not include (or utilize) worker 116 and the index hive 620 does not include (or utilize) essence cache.

As shown in this exemplary system 600, the media asset recording system 112 is communicatively coupled to a monitor 114 that is configured to obtain/receive a notification of when a new media asset has been generated or received in a similar manner as described above. In this regard, the media asset recording system 112 can maintain an event log of the status change (e.g., creation, modification, deletion) of each media asset that can be read out by the monitor 114.

Upon receiving the notification of any state change of the media asset, the monitor 114 is further configured to generate a new index or entry (or modify an existing entry) in the source index 118 coupled thereto and located in the source hive 610 for the quality copy (e.g., high resolution copy) of the new media asset. Likewise, the monitor 114 is further configured to generate a new index or entry (or modify an existing entry) in the local source index 118 for the one or more proxy copies (e.g., lower resolution copies) of the new media asset.

Moreover, the media asset recording system 112 stores both the quality and proxy copies of the media asset. Alternatively or in addition thereto, the source hive 610 can include an essence database 119 (e.g., a media asset or video server) that is communicatively coupled to the media asset recording system 112 and is further configured to store the quality and proxy copies of the media asset. In either case, the source index 118 can be further configured to store entries for each copy that includes metadata (e.g., content, resolution format, time length, copyright and ownership information, etc.) associated with each copy of the media asset and, most importantly, the address location of the media asset in the media asset recording system 112 and/or essence database 119, for example.

As also shown, the source index 124 of index hive 620 is communicatively coupled to source index 118. In this regard, the source index 124 can be configured to store corresponding entries of the media assets for each such entry that includes metadata (e.g., content, resolution format, time length, copyright and ownership information, etc.) associated with each proxy copy of the media asset stored in media recording system 112 and/or essence database 119, including the address location of the media asset therein. The metadata data can be provided from source hive 610 to index hive 620 (and specifically source index 124) using various techniques, such as on a push basis each time there is an update to the index information in source index 118 or, alternatively, on a pull basis in response to periodic requests by index hive 620, for example.

In addition, in a refinement of this aspect, the source index 124 can also store a media access reference, such as a URI or URL, that links the entry of the proxy copy of the media asset stored in the media recording system 112 and/or essence database 119 to the entries in the source index 118 that are associated with the different copies (e.g., quality and proxy) copies of the media asset.

In either case, when a web browser (e.g., web browser 210B) or a similar render engine generates a media asset request (e.g., a “query”) for a proxy copy stored in the source hive 610, the source index 124 redirects the query directly to the source hive 610 to enable the browser 210B to directly access the proxy copy of the media asset therefrom, in a similar manner as described above with respect to FIG. 2. Moreover, if the render machine 210B generates a query to source index 124 that requires a high quality copy of the media asset, the source index 124 is also configured to redirect the query to the source index 118. In turn, the source index 118 contains an entry therein that identifies the location of the high quality (or proxy) copy of the media asset in the media asset recording system 112 and/or essence database 119. Effectively, the render machine 210B is configured using the distributed graph of quality and proxy copies of the media asset to obtain the “best” essence copy directly from the media asset recording system 112 via index hive 620.

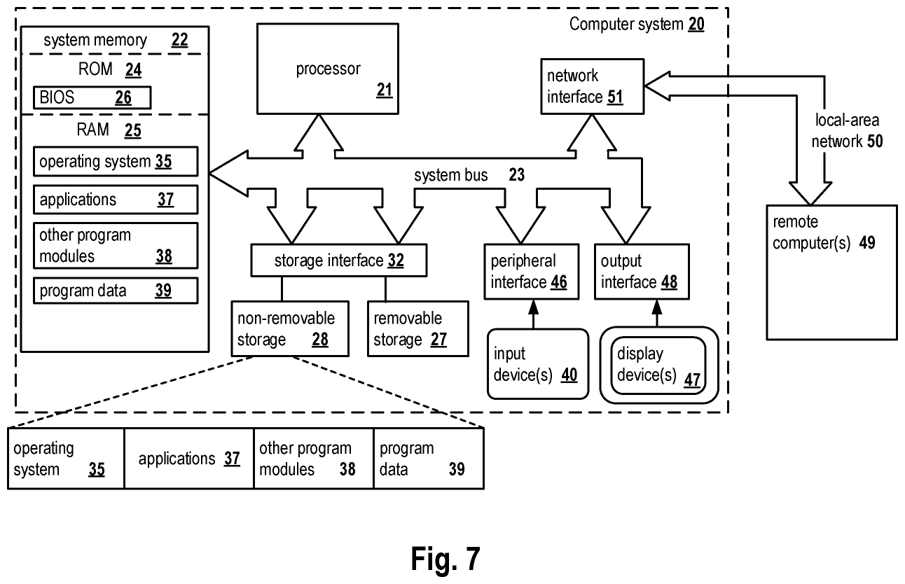

FIG. 7 is a block diagram illustrating a computer system 20 on which exemplary aspects of the system and method for building a distributed network for essence management and access can be implemented. It should be noted that the computer system 20 can correspond to the systems 100A, 100B, 200, 500 or 600, and/or any components therein. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable codes implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

As noted above, exemplary aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the systems described in greater detail in FIGS. 1A and 1B, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A system for building a distributed network for essence management and access, the system comprising:
a media asset recording system configured to generate a plurality of copies of a media asset including a high quality copy and at least one proxy copy of the media asset, with the high quality copy having a higher resolution than the at least one proxy copy;
a premises source index configured to store a plurality of media asset entries corresponding to each of the plurality of copies of the media asset, respectively;
a media asset monitor configured to dynamically update the respective media asset entries in the premises source index upon the media asset recording system generating the high quality copy and the at least one proxy copy of the media asset;
a worker configured to generate a copy of the at least one proxy copy of the media asset and write the generated copy of the at least one proxy copy to an essence cache of a cloud computing resource;
a cloud source index configured to generate at least one media asset entry corresponding to the generated copy of the at least one proxy copy in the essence cache of the cloud computing resource;
wherein the cloud source index is configured to generate a media access reference that dynamically links the at least one media asset entry to the plurality of media asset entries stored in the premises source index; and
wherein the cloud computing resource is configured to access the high quality copy of the media asset from the premises source index using the media access reference dynamically linking the respective copies of the media asset and in response to a media access request from a media request application on a client device, with the media access request including media asset parameters requiring the high quality copy of the media asset.

2. The system of claim 1, wherein the media request application comprises at least one of a web browser, an editing software, and a render engine.

3. The system of claim 2, wherein the media request application comprises a web browser that includes a plurality of user-defined fields that are configured to receive user inputs that enable a user to specify the media asset parameters that include a time needed for the high quality copy of the media asset and a resolution required for the high quality copy of the media asset.

4. The system of claim 1, further comprising an essence database communicatively coupled to the media asset recording system and configured to store the plurality of copies of the media asset including the high quality copy and the at least one proxy copy of the media asset.

5. The system of claim 4, wherein the premises source index is configured to store media asset metadata corresponding to the plurality of media asset entries, with the media asset metadata including a content type, a resolution format, a time length, and an ownership information of each corresponding media asset stored in the essence database.

6. The system of claim 4, wherein the cloud computing resource is configured to redirect the media access request to the premises source index to access the high quality copy of the media asset from the essence database when the media access request includes the media asset parameters that correspond to the media asset metadata identifying the respective media asset in the essence database.

7. A system for building a distributed network for essence management and access, the system comprising:
a media asset recording system configured to generate a plurality of copies of a media asset including a first copy and at least one second copy of the media asset that is a proxy of the first copy with a different quality than the first copy;
a first source index configured to store a plurality of media asset entries corresponding to each of the plurality of copies of the media asset, respectively;
a media asset monitor configured to dynamically update the respective media asset entries in the first index upon the media asset recording system generating at least one of the first and second copies of the media asset;
a worker configured to write the second copy of the media asset to an essence cache located remotely from the first source index;
a second source index coupled to the essence cache and located remotely from the first source index, with the second source index being configured to store at least one media asset entry corresponding to the second copy of the media asset that is in the essence cache;
wherein at least one of the first and second source indices is configured to generate a media access reference that dynamically links the at least one media asset entry therein to a corresponding media asset entry in the other of the first and second source indices; and
wherein at least one of the first and second source indices is configured to access one of the first and second copies of the media asset from other of the first and second source indices using the media access reference dynamically linking the respective copy of the media asset and in response to a media access request from a media request application on a client device, with the media access request including media asset parameters for requesting the one of the first and second copies of the media asset.

8. The system of claim 7, wherein the media request application comprises at least one of a web browser, an editing software, and a render engine.

9. The system of claim 8, wherein the media request application comprises a web browser that includes a plurality of user-defined fields that are configured to receive user inputs that enable a user to specify the media asset parameters that include a time needed for the requested copy of the media asset and a resolution required for the requested copy of the media asset.

10. The system of claim 7, further comprising an essence database communicatively coupled to the media asset recording system and configured to store the plurality of copies of the media asset including the first and second copies of the media asset.

11. The system of claim 10, wherein the first source index is configured to store media asset metadata corresponding to the plurality of media asset entries, with the media asset metadata including a content type, a resolution format, a time length, and an ownership information of each corresponding media asset stored in the essence database.

12. The system of claim 11, wherein at least one of the first and second source indices is comprised within a cloud computing resource that is configured to redirect the media access request to the other of the first and second source indices to access the one copy of the media asset from the essence database when the media access request includes the media asset parameters that correspond to the media asset metadata identifying the respective media asset in the essence database.

13. A system for building a distributed network for essence management and access, the system comprising:
a media asset recording system configured to generate a plurality of copies of a media asset including a high quality copy and a proxy copy of the media asset that has a lower resolution than the high quality copy;
an essence database configured to store each of the plurality of copies of the media asset;
a first source index configured to store a plurality of media asset entries corresponding to each of the plurality of copies of the media asset, respectively, wherein each of the plurality of media asset entries including metadata for each respective copy, with the metadata including at least a resolution, a video codec and an audio codec information relating to the respective copy;
a media asset monitor configured to dynamically update the respective media asset entries in the first source index upon the media asset recording system generating at least one of the high quality copy and the proxy copy of the media asset; and
a media essence provider configured to access a copy of the media asset having a highest available resolution in response to a media access request from a media request application on a client device that specifies required parameters for the media asset, such that the media essence provider references the first source index to identify the copy of the media asset having the highest available resolution based on the specified and required parameters for the media asset.

14. The system according to claim 13, further comprising:
a worker configured to write the proxy copy of the media asset to an essence cache located remotely from the first source index;
a second source index coupled to the essence cache and located remotely from the first source index, with the second source index being configured to store at least one media asset entry corresponding to the second copy of the media asset that is in the essence cache;
wherein at least one of the first and second source indices is configured to generate a media access reference that dynamically links the at least one media asset entry therein to a corresponding media asset entry in the other of the first and second source indices.

15. The system according to claim 14, wherein at least one of the first and second source indices is configured to access one of the high quality and proxy copies of the media asset from other of the first and second source indices using the media access reference dynamically linking the respective copy of the media asset and in response to the media access request from a media request application on a client device, with the media access request including media asset parameters for requesting the respective copy of the media asset.

16. The system of claim 13, wherein the media request application comprises at least one of a web browser, an editing software, and a render engine.

17. The system of claim 13, wherein the media request application comprises a web browser that includes a plurality of user-defined fields that are configured to receive user inputs that enable a user to specify the media asset parameters that include a time needed for the high quality copy of the media asset and a resolution required for the high quality copy of the media asset.

18. The system of claim 13, further comprising an essence database communicatively coupled to the media asset recording system and configured to store the plurality of copies of the media asset.

19. The system of claim 18, wherein the first source index is configured to store media asset metadata corresponding to the plurality of media asset entries, with the media asset metadata including a content type, a resolution format, a time length, and an ownership information of each corresponding media asset stored in the essence database.

20. The system of claim 19, wherein at least one of the first and second source indices is comprised within a cloud computing resource that is configured to redirect the media access request to the other of the first and second source indices to access the one copy of the media asset from the essence database when the media access request includes the media asset parameters that correspond to the media asset metadata identifying the respective media asset in the essence database.
